(19) United States
(12) Patent Application Publication
(10) Pub. No.: US 2026/0052604 A1
(43) Pub. Date: Feb. 19, 2026

(54) COOKING APPLIANCE AND METHOD FOR ADJUSTING PREHEATING POWER WITH SETPOINT CHANGE

(71) Applicant: Haier US Appliance Solutions, Inc., Wilmington, DE (US)

(72) Inventor: Omar Santana, Louisville, KY (US)

(21) Appl. No.: 18/808,557

(22) Filed: Aug. 19, 2024

(51) Int. Cl. H05B 1/02; F24C 7/08; G05D 23/19

(52) U.S. Cl. CPC H05B 1/0266; F24C 7/087; G05D 23/1904; H05B 2213/07

(57) ABSTRACT

A cooking appliance and method for operation include initiating a preheating operation based on an initial temperature setpoint, a preheating phase duration, and an initial power level. One or more temperature setpoint changes each corresponding to respective setpoint change times are obtained during the preheating operation. Each temperature setpoint change includes a respective second power level. The preheating operation is adjusted to an adjusted power level based on a first attribute including the preheating phase duration and the sequentially latest power level, a second attribute including a sum of each power level applied during the preheating phase duration and each elapsed duration over which each power level is applied during the preheating phase duration, and a ratio of a difference of the first attribute and the second attribute to a difference of the preheating phase duration and a sum of each elapsed duration over which each power level is applied.

### FIELD OF THE INVENTION

The present subject matter relates generally to cooking appliances, and more particularly to methods for operating a cooking appliance with temperature setpoint changes.

### BACKGROUND OF THE INVENTION

Cooking appliances generally have one or more heating elements configured for heating a cookware item. The cookware item, e.g., a pot or a pan, may be positioned on or near the one or more heating elements and food products (including, e.g., food solids, liquid, or water) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products until they are properly cooked.

For cooking appliances that are capable of performing feedback controlled heating operations, one or more algorithms may be used to incorporate certain feedback information (e.g., temperature change, temperature rate of change, etc.) over a heating duration to control a power level of the heating element(s). For a preheating algorithm where a setpoint-dependent power level is applied for the duration of the preheating phase, recommended power levels may be determined empirically. For instance, a predetermined power level applied for the duration of the preheating phase is expected to bring the cookware item to a temperature setpoint.

However, existing methods of operating such cooking appliances suffer certain drawbacks. For instance, preheating algorithms do not account for a user changing the temperature setpoint during the preheating phase. As such, existing methods for operating such cooking appliances may result in temperature at the end of the preheating phase being substantially different from the temperature setpoint (e.g., higher or lower, beyond a tolerance or range, than the temperature setpoint).

Accordingly, a cooking appliance and method for operating a cooking appliance which obviates one or more of the above-mentioned drawbacks would be beneficial.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a cooking appliance including a heating element configured to selectively supply heat to a cookware item, and a controller operably connected to the heating element. The controller is configured to perform operations. The operations include obtaining an initial temperature setpoint; obtaining, based on the initial temperature setpoint, a preheating phase duration and an initial power level; initiating a preheating operation based on the preheating phase duration and the initial power level; obtaining one or more temperature setpoint changes each corresponding to respective setpoint change times during the preheating operation, wherein each temperature setpoint change includes a respective second power level; and adjusting the preheating operation to an adjusted power level. The adjusted power level is based on a first attribute including the preheating phase duration and the sequentially latest power level of the one or more temperature setpoint changes; a second attribute including a sum of each power level applied during the preheating phase duration, and each elapsed duration over which each power level is applied during the preheating phase duration; and a ratio of a difference of the first attribute and the second attribute to a difference of the preheating phase duration and a sum of each elapsed duration over which each power level is applied.

An aspect of the present disclosure is directed to a cooking appliance including a heating element configured to selectively supply heat to a cookware item; and a controller operably connected to the heating element, the controller configured to perform operations. The operations include obtaining an initial temperature setpoint; obtaining, from a database, a preheating phase duration corresponding to the initial temperature setpoint; obtaining, from the database, an initial power level corresponding to the initial temperature setpoint; initiating a preheating operation based on the preheating phase duration and the initial power level; obtaining, at a setpoint change time during the preheating operation, a temperature setpoint change; obtaining, from the database, a second power level corresponding to the temperature setpoint change; and adjusting the preheating operation to an adjusted power level during the preheating phase duration. The adjusted power level is based on a first attribute including the preheating phase duration and the second power level; a second attribute including a duration over which the initial temperature setpoint was active and the initial power level at which the preheating operation is performed; and a ratio of a difference of the first attribute and the second attribute to a difference of the preheating phase duration and the duration over which the initial temperature setpoint was active.

An aspect of the present disclosure is directed to a method for operating a closed loop cooking appliance. The cooking appliance includes a heating element and a temperature sensor. The method includes obtaining a first temperature setpoint; obtaining, from a database, a preheating phase duration and a first power level corresponding to the first temperature setpoint; initiating a preheating operation based on the preheating phase duration and the first power level corresponding to the first temperature setpoint; obtaining, at a setpoint change time during the preheating operation, a second temperature setpoint; obtaining, from the database, a second power level corresponding to the second temperature setpoint; and adjusting the preheating operation to an adjusted power level. The adjusted power level is based on a first attribute including the preheating phase duration and the second power level; a second attribute including a duration over which the first temperature setpoint was active and the initial power level; and a ratio of a difference of the first attribute and the second attribute to a difference of the preheating phase duration and the duration over which the first temperature setpoint was active.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven range according to exemplary embodiments of the present disclosure.

FIG. 2 provides a side cut-away view of the exemplary oven range of FIG. 1.

FIG. 3 provides a table illustrating an exemplary predetermined preheating power level and duration for various temperature setpoints.

FIG. 4A provides a graph illustrating an exemplary power level adjustment with a temperature setpoint change in accordance with aspects of the present disclosure.

FIG. 4B provides a graph illustrating an exemplary power level adjustment with a temperature setpoint change, including exemplary non-limiting values, in accordance with an aspect of the present disclosure.

FIG. 5 provides a flowchart outlining steps of a method for operating a cooking appliance in accordance with aspects of the present disclosure.

FIG. 6A provides a graph illustrating an exemplary power level versus preheating phase duration in accordance with aspects of the present disclosure.

FIG. 6B provides a graph illustrating an exemplary power level versus preheating phase duration in accordance with aspects of the present disclosure.

FIG. 7A provides a graph illustrating an exemplary power level versus preheating phase duration in accordance with aspects of the present disclosure.

FIG. 7B provides a graph illustrating an exemplary power level versus preheating phase duration in accordance with aspects of the present disclosure.

FIG. 8 provides a graph illustrating an exemplary power level versus preheating phase duration in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a cooking appliance and a method for operating a cooking appliance are provided that address one or more of the aforementioned issues. In various embodiments of a cooking appliance configured for a closed-loop cooking (CLC) process, a power level applied by the cooktop heating element can vary from 0% (minimum) to 100% (maximum). During CLC, a user provides, directly or indirectly, a temperature setpoint or target for the food (e.g., direct temperature selection, or indirect temperature selection corresponding to a food type selection, cooking menu, etc.). In various embodiments, the cooking appliance is configured to apply constant power for a predefined amount of time during the preheating phase, in contrast to including a temperature error-based algorithm (e.g., a proportional-integral-derivative (PID) controller). For instance, the cooking appliance is configured to apply constant power for a predefined amount of time during the preheating phase, in contrast to the amount of power applied depending on current temperature error between a sensor temperature and a temperature setpoint and changes thereto throughout the preheating and cooking processes. The initial power level applied may be determined by the user-defined temperature setpoint. Embodiments of the apparatus and control method provided herein adjust a predetermined preheating power level after a temperature setpoint change is received from the user (e.g., from user articulation of a dial or input that changes the temperature setpoint). Methods, controllers, and cooking appliances such as provided herein may beneficially and advantageously improve accuracy and efficiency, reduce energy consumption, and avoid overheating or underheating the cookware.

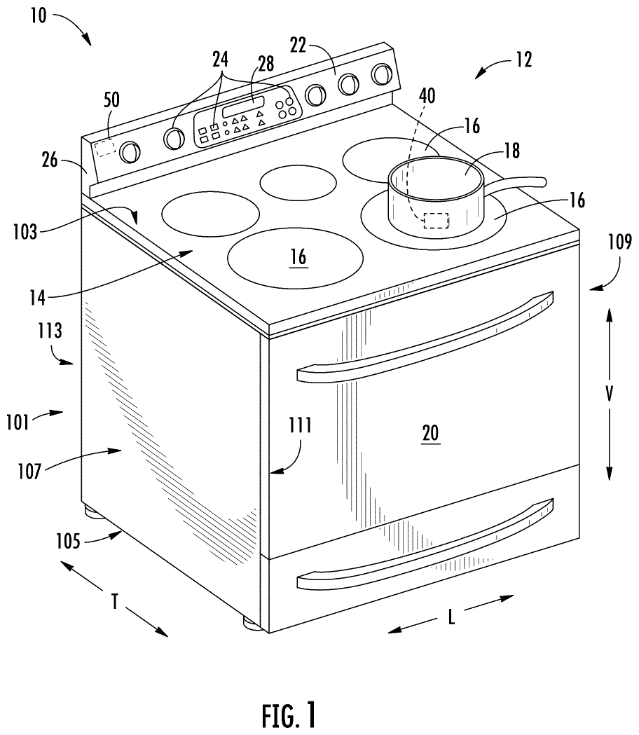

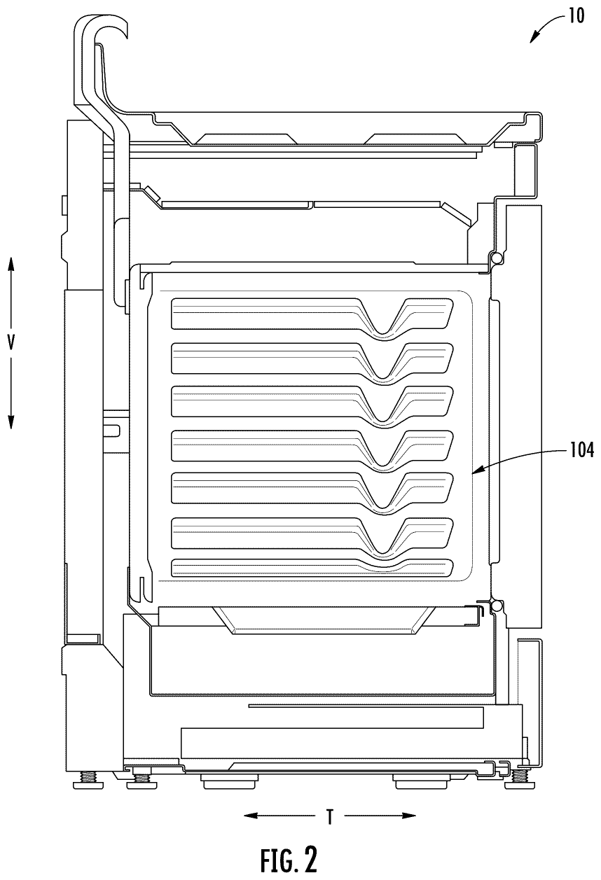

FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally, or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As mentioned, heating element 16 may be an induction style heating element. Thus, as would be understood by those skilled in the art, appliance 10 may supply a current to heating element 16 (e.g., such as a Lenz coil). As such, current may pass through heating element 16 to generate a magnetic field. The magnetic field may be a high frequency circulating magnetic field. The magnetic field may be directed towards and through cooktop appliance 12 to a cookware item (e.g., cookware item 18, described below). In particular, when the magnetic field penetrates cookware item 18, the magnetic field induces a circulating electrical current within cookware item 18. The material properties of cookware item 18 may restrict a flow of the induced electrical current and convert the induced electrical current into heat within cookware item 18. As cookware item 18 heats up, contents of cookware item 18 contained therein heat up as well. In such a manner, the induction heating element can cook the contents of cookware item 18.

As shown in FIG. 1, a cooking utensil (or cookware item) 18, such as a pot, pan, or the like, may be placed on a heating element 16 to heat cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally, or alternatively, display 28 may be a touch display capable of receiving touch inputs from a user.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a temperature sensor 40. Temperature sensor 40 may be configured to selectively sense a temperature of a cookware item (e.g., cookware item 18) as it is heated. For instance, temperature sensor 40 may be integrally formed with cooking appliance 10 (e.g., within cooktop 12, within cooking chamber 104, etc.). In some embodiments, temperature sensor 40 is operably connected to cooking appliance 10 (e.g., via a port or socket, via a remote connection, etc.). For one example, temperature sensor 40 is provided within cookware item 18 and operably connected to controller 50 during a cooking operation. Temperature sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

In various embodiments, temperature sensor 40 is configured to monitor a temperature of the cookware item 18. For instance, the temperature sensor 40 is operably connected to the controller 50 to perform operations (e.g., steps of method 500) from a starting temperature obtained from the temperature sensor 40. For instance, operations may include monitoring, via the temperature sensor, a temperature of the cookware item.

As used herein, “temperature sensor” or the equivalent is intended to refer to any suitable type of temperature measuring system or device positioned at any suitable location for measuring the desired temperature. Thus, for example, temperature sensor 40 may be any suitable type of temperature sensor, such as a thermistor, a thermocouple, a resistance temperature detector, a semiconductor-based integrated circuit temperature sensor, etc. In addition, temperature sensor 40 may be positioned at any suitable location and may output a signal, such as a voltage, to a controller that is proportional to or indicative of the temperature being measured. Although exemplary positioning of temperature sensors is described herein, it should be appreciated that appliance 10 may include any other suitable number, type, and position of temperature or other sensors according to alternative embodiments.

Now that the construction of cooking appliance 10 and a configuration of controller 50 according to exemplary embodiments have been presented, exemplary method for operating a cooking appliance will be described (hereinafter, “method 500”). Although the discussion herein refers to the exemplary method 500 for operating cooking appliance 10, one skilled in the art will appreciate that the exemplary method 500 is applicable to the operation of a variety of other cooking appliances, e.g., closed-loop cooking (CLC) appliances generally. In exemplary embodiments, the various method steps as disclosed herein may be performed by controller 50 or a separate, dedicated controller.

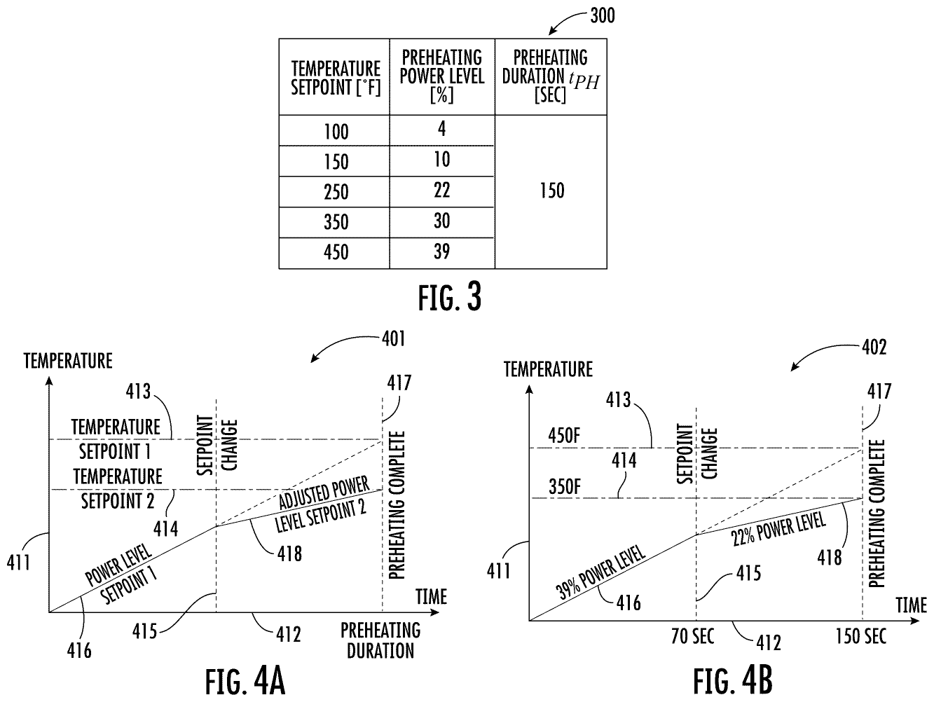

FIG. 3 provides a table 300 illustrating an exemplary predetermined preheating power level and duration for various temperature setpoints. Table 300 provides the same preheating duration for all temperature setpoints, however, it should be appreciated that the preheating duration may vary with the setpoint (i.e., a different preheating duration for one or more temperature setpoints). For example, the preheating duration may be shorter for lower temperature setpoints and longer for higher temperature setpoints. Temperature setpoints between the predetermined values provided in table 300 may be interpolated to determine preheating power level, duration, or both.

FIG. 4A provides a graph 401 illustrating an exemplary power level adjustment with a temperature setpoint change (axis 411) over time (axis 412). FIG. 4B provides a graph 402 illustrating an exemplary power level adjustment with a temperature setpoint change over time using non-limiting exemplary values. Graphs 401, 402 depict an initial temperature setpoint (line 413, “temperature setpoint 1”), a temperature setpoint change (line 414, “temperature setpoint 2”), and a time at which the temperature setpoint is changed (line 415, “setpoint change”). An initial power level (line 416, “power level setpoint 1”) corresponding to temperature setpoint 1 and preheating phase duration (line 417, “preheating complete”) is applied, such as via user input (e.g., directly or indirectly through controls 24 or display 28, or from controller 50).

After the user changes the temperature setpoint (i.e., after receiving temperature setpoint 2, e.g., through controls 24, display 28, or controller 50), an adjusted power level (line 418, “adjusted power level setpoint 2”) corresponding to the temperature setpoint change (line 414, “temperature setpoint 2”) extends from the setpoint change time (line 415) to achieve the temperature setpoint 2 during the preheating phase duration (line 417).

For instance, referring to FIG. 4B, an initial temperature setpoint of 450 degrees Fahrenheit (F) may be received. Referring to table 300 (FIG. 3), a corresponding preheating power level for 450 F is 39% for a preheating phase duration of 150 seconds. At time 70 seconds, the setpoint change is received and the temperature setpoint change (temperature setpoint 2) is 350 F. Method 500, further described herein, determines the adjusted power level at 22% for 350 F from the setpoint change at 70 seconds, in contrast to a preheating power level of 30% for 350 F from the initial temperature setpoint from table 300.

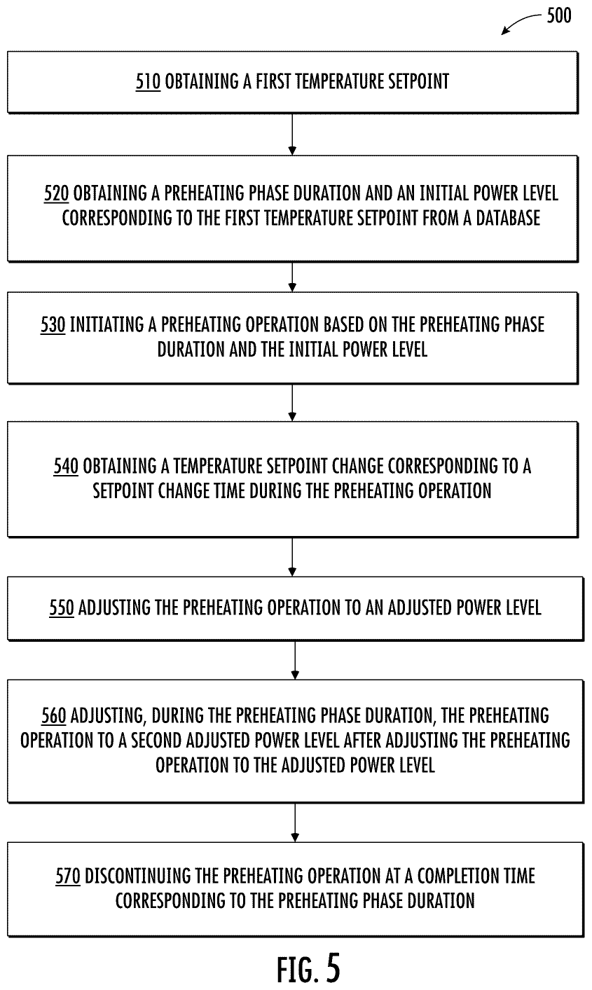

FIG. 5 provides an exemplary flowchart outlining steps of the method 500 for operating a closed-loop cooking appliance, such as in accordance with embodiments depicted and described in regard to FIGS. 1-2. Steps of method 500 include a method for adjusting power level during the preheating operation after obtaining a temperature setpoint change. It should be appreciated that steps of method 500 may be stored as instructions that, when executed, cause a cooking appliance to perform operations. In various embodiments, instructions are stored at controller 50 in any desired coding format. Additionally, instructions may be stored at controller 50 or distributed across controller 50 and one or more other computing devices (e.g., remote computing device, cloud computing device, etc.). As generally described herein, steps of method 500 may be stored and/or executed at a controller (e.g., controller 50) operably connected to a heating element. The heating element is configured to perform heating operations based on commands or signals based on method 500, such as signals obtained, received, or transmitted to/from the controller.

Method 500 includes at 510 obtaining a first or an initial temperature setpoint, such as described regarding temperature setpoint 1. Method 500 includes at 520 obtaining, based on the initial temperature setpoint, a preheating phase duration and a first or initial power level. In various embodiments, the initial temperature setpoint corresponds to start of the preheating operation (e.g., t=0).

Method 500 includes at 520 obtaining the preheating phase duration and the initial power level corresponding to the initial temperature setpoint from a database, such as a lookup table, schedule, chart, other reference, such as exemplarily depicted and described in regard to FIG. 3. For instance, referring to FIGS. 4A-4B, method 500 at 510 may include obtaining, from the user, a command signal corresponding to temperature setpoint 1 (e.g., line 413 in FIGS. 4A-4B, such as exemplary setpoint of 450 F in FIG. 4B). Method 500 at 520 obtains (e.g., from a database such as exemplarily depicted in FIG. 3) the initial power level (e.g., 39%) for a preheating phase duration (e.g., 150 seconds) corresponding to the temperature setpoint 1.

Method 500 includes at 530 initiating a preheating operation based on the preheating phase duration and the initial power level. For instance, referring to FIGS. 4A-4B, method 500 at 530 includes initiating the preheating operation for the preheating phase duration such as corresponding to line 417 and the initial power level corresponding to line 416 (power level setpoint 1).

Method 500 includes at 540 obtaining a temperature setpoint change corresponding to a setpoint change time during the preheating operation. For instance, referring to FIGS. 4A-4B, method 500 at 540 includes obtaining, during the preheating operation (e.g., at time<150 seconds in FIG. 4B), the temperature setpoint change such as corresponding to line 415 (e.g., at time=70 seconds in FIG. 4B). In various embodiments, method 500 at 540 includes obtaining one or more temperature setpoint changes each corresponding to respective setpoint change times during the preheating operation. In still various embodiments, obtaining one or more temperature setpoint changes is in serial sequence corresponding to respective setpoint change times, setpoint durations, and power levels, such as further described herein.

Each temperature setpoint change includes a respective database or lookup table power level (e.g., respective second power levels), such as described in regard to FIG. 3. Referring to FIG. 4B, in an exemplary non-limiting embodiment, the user inputs a command for a temperature setpoint change from temperature setpoint 1 (line 413, e.g., 450 F) to temperature setpoint 2 (line 414, e.g., 350 F) at the setpoint change time (line 415, e.g., 70 seconds). Referring to FIG. 3, a preheating power level corresponding to a temperature setpoint of 350 F corresponds to a 30% power level. However, as previously stated and further described herein, method 500 may determine the adjusted power level at 22% for 350 F (line 418 in FIG. 4B) from the setpoint change at 70 seconds, in contrast to a preheating power level of 30% corresponding to a temperature setpoint of 350 F, according to table 300.

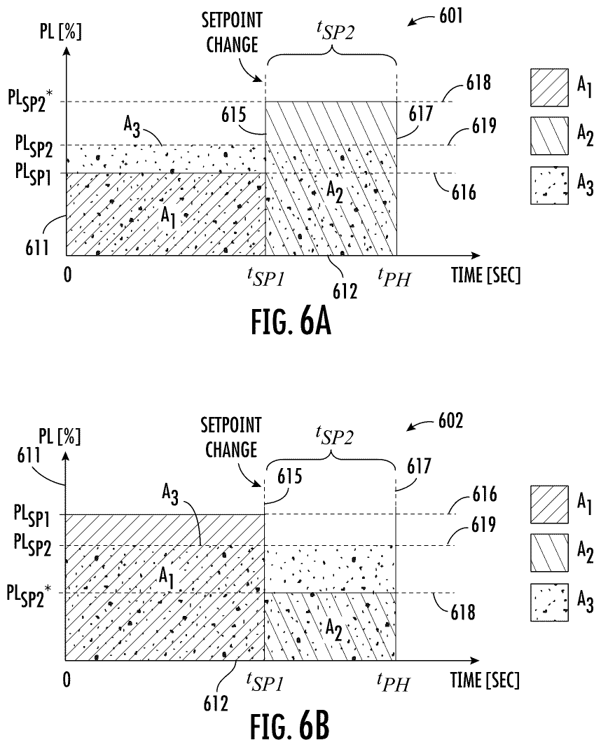

Referring now to FIGS. 6A-6B, graphs 601, 602 illustrating an aspect of the method 500 are provided. Graphs 601, 602 illustrate generally a power area under the curve including an exemplary power level (axis 611) versus preheating phase duration (axis 612). Graph 601 illustrates an exemplary temperature setpoint increase. Graph 602 illustrates an exemplary temperature setpoint decrease.

Area A₁ illustrates an observed power area while the first or initial temperature setpoint is active. Area A₁ corresponds to an area extending from time t=0 at axis 611 to setpoint change time at line 615 (corresponding to setpoint change time 415 in FIGS. 4A-4B), and extending from axis 612 to a first power level PL_{SP1} at line 616 (corresponding to first power level 416 in FIGS. 4A-4B).

Area A₂ illustrates a desired power area while the second temperature setpoint is active.

Area A₃ illustrates an expected power area if the second temperature setpoint were active from start (t=0) to finish (i.e., the preheating phase duration corresponding to the second temperature setpoint, such as provided in FIG. 3) at the power level recommended in FIG. 3 (PL_{SP2}).

For instance, referring to the example at FIG. 4B, the user inputs the second temperature setpoint of 350 F at 70 seconds into the preheating phase duration. However, referring to the example of FIG. 3, the preheating power level corresponding to 350 F is 30% for 150 seconds. Area A₃ represents the expected power area if the second temperature setpoint (e.g., 350 F) were active from start to 150 seconds. Area A₃ corresponds to an area extending from time t=0 at axis 611 to the preheating completion at line 617 (e.g., 150 seconds based on FIG. 3), and extending from axis 612 to a second power level PL_{SP2} at line 619 (e.g., 30% corresponding to second temperature setpoint 350 F at FIG. 3).

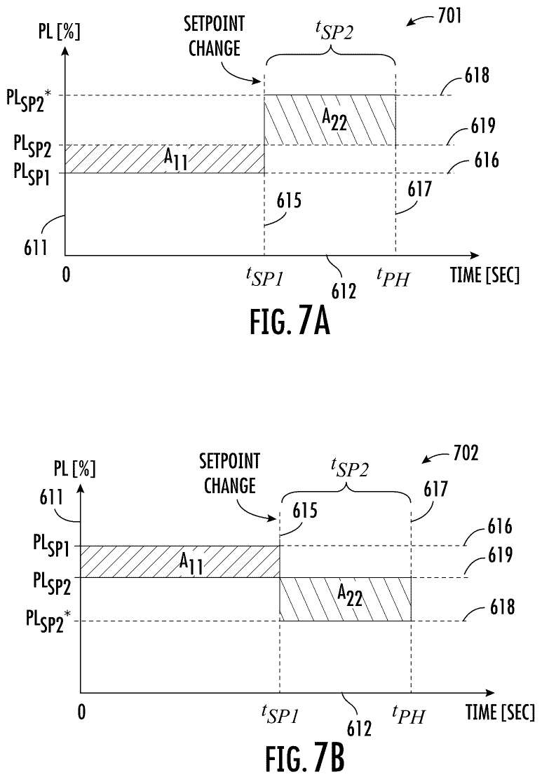

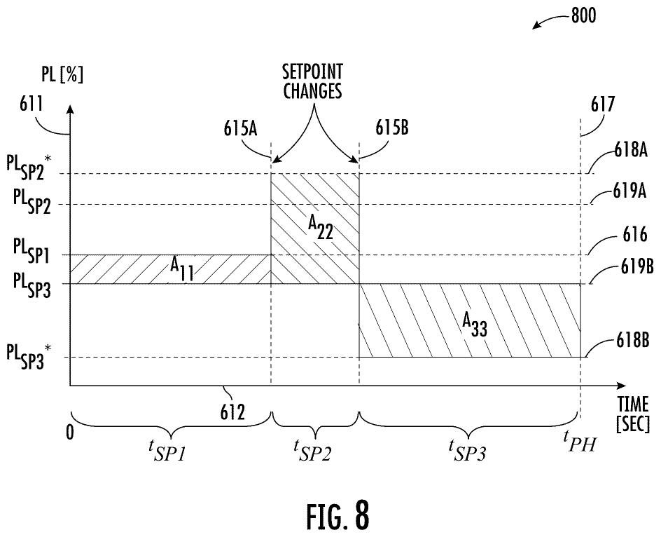

Referring to FIGS. 7A-7B, graphs 701, 702 illustrate an additional or alternative aspect of the method 500. Graphs 701, 702 illustrate generally a power area under the curve depicting a difference between recommended power levels (e.g., obtained from database or lookup table, such as depicted in FIG. 3) for first and second temperature setpoints.

Area A₁₁ illustrates an observed power area difference between recommended power levels for first and second temperature setpoints.

Area A₂₂ illustrates a desired power area difference between adjusted and recommended power levels for the second temperature setpoint.

Referring to FIG. 7A, A₁₁ represents the power area to be added for the remainder of the preheating phase after a setpoint change (A₂₂) to adjust for running at a lower power level (PL_{SP1}<PL_{SP2}) for the first t_{SP1} seconds.

Referring to FIG. 7B, A₁₁ represents the power area to be subtracted for the remainder of the preheating phase after a setpoint change (A₂₂) to adjust for running at a higher power level (PL_{SP1}>PL_{SP2}) for the first t_{SP1} seconds.

Method 500 includes at 550 adjusting the preheating operation to an adjusted power level. Since method 500 at 530 runs at power area A₁ (e.g., depicted in FIGS. 6A-6B) for a duration corresponding from start to setpoint change time 615 (e.g., line 415 in FIGS. 4A-4B) obtained at 540, method 500 at 550 adjusts the power level area A₂ such that a total area A₁+A₂ equals the desired area A₃. Method 500 at 550 includes determining an adjusted power level for the latest temperature setpoint based on a recommended power level for the latest setpoint (i.e., the second power level corresponding to the temperature setpoint change, such as based on the exemplary database depicted in FIG. 3), a total preheating duration (i.e., the preheating duration corresponding to the first temperature setpoint, such as based on the exemplary database depicted in FIG. 3), and power level and duration for each previous temperature setpoint (e.g., the initial temperature setpoint and each subsequent temperature setpoint during the preheating phase duration).

As such, method 500 at 550 adjusts the power level and applies the adjusted power level during the preheating operation with each temperature setpoint change (e.g., PL_{SP2}* in FIGS. 6A-6B, line 618) in contrast to applying the power level corresponding to the database (e.g., in contrast to applying the power level PL_{SP2} in FIGS. 6A-6B, line 619, according to FIG. 3).

For instance, referring to FIG. 4B, method 500 at 550 adjusts the applied power level to 22% power level to achieve the second temperature setpoint of 350 F (i.e., the setpoint change) instead of applying the power level of 30% corresponding to the 350 F temperature setpoint of the database. As such, method 500 adjusts the power level to bring the cookware temperature to the second temperature setpoint (“temperature setpoint 2”) to achieve the total power area equal to area A₃ corresponding to the second temperature setpoint.

In some embodiments, method 500 at 550 includes adjusting the preheating operation to an adjusted power level based on a first attribute, a second attribute, and a ratio of a difference of the first attribute and the second attribute to a difference of the preheating phase duration and the duration over which the initial temperature setpoint was active.

In some embodiments, the ratio includes:

$${PL}_{SP 2}^{*} = \frac{{t}_{PH} * {PL}_{SP 2} - {t}_{SP 1} * {PL}_{SP 1}}{{t}_{PH} - {t}_{SP 1}}$$

in which t_{PH} is the preheating phase duration based on a lookup table or database (e.g., FIG. 3) corresponding to the initial temperature setpoint; t_{SP1} is the length of time or duration over which the first or initial temperature setpoint is active; PL_{SP1} is the first or initial power level based on the database corresponding to the first temperature setpoint (e.g., FIG. 3); PL_{SP2} is the second power level based on the database corresponding to the second temperature setpoint (e.g., FIG. 3); and PL_{SP2}* is the determined adjusted power level for second temperature setpoint. As shown in FIGS. 6A-6B, t_{SP2} is the length of time or duration over which the second temperature setpoint (i.e., the temperature setpoint change) is active.

The first attribute includes the preheating phase duration and the second power level. For instance, the first attribute includes the preheating phase duration (t_{PH}) and the second power level (PL_{SP2}) based on the database corresponding to the temperature setpoint change (the second temperature setpoint).

The second attribute includes the duration over which the initial temperature setpoint was active and the initial power level at which the preheating operation is performed. For instance, the second attribute includes the duration over which the initial temperature setpoint was active (t_{SP1}) and the initial power level at which the preheating operation is performed (PL_{SP1}).

For instance, referring to exemplary non-limiting embodiment of FIG. 3 and FIG. 4B, the t_{PH} is the preheating phase duration of 150 seconds based on a lookup table or database corresponding to the initial temperature setpoint of 450 F; t_{SP1} is the length of time or duration of 70 seconds over which the first or initial temperature setpoint was active until the temperature setpoint change is obtained (e.g., line 415); t_{SP2} is the duration of 80 seconds over which the second temperature setpoint is active; PL_{SP1} is the first power level of 39% based on the database corresponding to the first temperature setpoint of 450 F; PL_{SP2} is the second power level of 30% based on the database corresponding to the second temperature setpoint of 350 F; and PL_{SP2}* is the determined adjusted power level of 22% for second temperature setpoint of 350 F (e.g., depicted at line 418).

In some embodiments, method 500 includes at 560 adjusting, during the preheating phase duration, the preheating operation to a second adjusted power level after adjusting the preheating operation to the adjusted power level (e.g., a first adjusted power level). Method 500 at 560 includes obtaining a plurality of temperature setpoint changes. For example, method 500 may include obtaining a plurality of second temperature setpoints.

For instance, referring to FIG. 8, graph 800 illustrates an additional or alternative aspect of the method 500 in which a plurality of second temperature setpoints is obtained. In the present non-limiting example, a first temperature setpoint provides an initial temperature setpoint; a second temperature setpoint provides a first setpoint change; and a third temperature setpoint provides a second setpoint change sequentially after the first setpoint change. Graph 800 illustrates generally a power area under the curve depicting a difference between recommended power levels for the first temperature setpoint (line 616), the second temperature setpoint (line 619A) obtained sequentially after the first temperature setpoint, and the third temperature setpoint (line 619B) obtained sequentially after the second temperature setpoint.

Area A₁₁ illustrates an observed power area difference between recommended power levels for the first temperature setpoint (line 616) and the third temperature setpoint (line 619B, obtained at time corresponding to line 615B).

Area A₂₂ illustrates an observed power area difference between adjusted power level for the second temperature setpoint (line 618A, obtained at time corresponding to line 615A) and recommended power level for the third temperature setpoint (line 619B).

Area A₃₃ illustrates a desired power area difference between adjusted and recommended power levels for the third temperature setpoint (e.g., PL_{SP3}* and PL_{SP3}, lines 618B and 619B, respectively).

Method 500 at 550 includes adjusting the preheating operation to an adjusted power level based on a first attribute, a second attribute, a third attribute, and a ratio of a difference of the first, second, and third attributes to a difference of the preheating phase duration and the duration over which each previous temperature setpoint was active.

In some embodiments, the ratio includes

$${PL}_{SP 3}^{*} = \frac{{t}_{PH} * {PL}_{SP 3} - {t}_{SP 2} * {PL}_{SP 2}^{*} - {t}_{SP 1} * {PL}_{SP 1}}{{t}_{PH} - {t}_{SP 1} - {t}_{SP 2}}$$

in which PL_{SP3} is the sequentially latest database power level (e.g., FIG. 3) corresponding to the sequentially latest temperature setpoint change; PL_{SP2}* is the determined adjusted power level for the previous temperature setpoint change; PL_{SP1} is the initial database power level (e.g., FIG. 3) corresponding to the initial temperature setpoint; t_{PH} is the database preheating phase duration corresponding to the initial temperature setpoint; t_{SP1} is the duration over which the initial temperature setpoint was active; and t_{SP2} is the duration over which the subsequent temperature setpoint was active (i.e., the duration corresponding to the duration of PL_{SP2}*); Referring to FIG. 8, t_{SP3} is the duration over which the sequentially latest temperature setpoint is active.

A first attribute includes the preheating phase duration (t_{PH}) and the sequentially latest database power level (PL_{SP3}). A second attribute includes the duration over which the second temperature setpoint is active (t_{SP2}) and the adjusted power level corresponding to the second temperature setpoint (PL_{SP2}*). A third attribute includes the duration over which the initial temperature setpoint is active (t_{SP1}) and the initial power level corresponding to the initial temperature setpoint (PL_{SP1}).

In some embodiments, method 500 at 550 includes determining an adjusted power level for the sequentially latest temperature setpoint change (PL_{SP3}*) based on the first attribute, the second attribute, the third attribute, and a ratio of a difference of the first, second, and third attributes to a difference of the preheating phase duration and the durations over which each previous temperature setpoint was active.

In various embodiments, method 500 includes adjusting the preheating operation based on determining an adjusted power level including a first attribute, a second attribute, and a ratio of a difference of the first attribute and the second attribute to a difference of the preheating phase duration and a sum of each elapsed duration over which each power level is applied.

In some embodiments, the ratio includes

$${PL}_{{SP}_{N}}^{*} = \frac{{t}_{PH} * {PL}_{{SP}_{N}} - {\sum }_{i = 1}^{N - 1} ( {t}_{{SP}_{i}} * {PL}_{{SP}_{i}}^{*} )}{{t}_{PH} - {\sum }_{i = 1}^{N - 1} {t}_{{SP}_{i}}}$$

The first attribute includes the preheating phase duration (t_{PH}) and the sequentially latest database power level (PL_{SP}_{_{N}}) of the one or more temperature setpoint changes. The second attribute includes a sum of each power level applied during the preheating phase duration (PL_{SP}_{ᵢ}*), and each elapsed duration over which each power level is applied (t_{SP}_{ᵢ}) during the preheating phase duration. N is the total quantity of temperature setpoints up to obtaining the sequentially latest temperature setpoint change. PL_{SP}_{_{N}}* is the adjusted power level for the sequentially latest temperature setpoint N.

In various embodiments, limits may be included relative to power level, application times, or changes therein. In some embodiments, adjusting the preheating operation does not exceed a maximum power level of the cooking appliance. For instance, adjusted power levels are clamped to an allowed power level range (e.g., an allowed power level range not exceeding below 0% or above 100%).

In still some embodiments, adjusting the preheating operation is inhibited within a time range prior to preheating operation completion (e.g., t_{PH}−X). For instance, in an exemplary non-limiting embodiment, adjusting the preheating operation is inhibited within 10 seconds, or 20 seconds, or 30 seconds, etc. from the preheating completion time.

In still yet some embodiments, the setpoint temperature change may be limited to a maximum change magnitude. For instance, in an exemplary non-limiting embodiment, a temperature setpoint increase may be limited to 50 F from the previous setpoint, or a temperature setpoint decrease may be limited to 60 F from the previous setpoint, etc.

In still some embodiments, method 500 may limit the quantity of setpoint changes (e.g., limited to one, or two, or three, etc. setpoint changes within the preheating phase duration).

In still various embodiments, method 500 includes at 570 discontinuing the preheating operation at a completion time corresponding to the preheating phase duration. Discontinuing the preheating operation may include transitioning to another cooking process, such as, but not limited to, a standby process, a process for maintaining a steady-state cookware temperature, or a predetermined cooking process.

Embodiments of the method 500 provided herein may include attributes, ratios, products, or differences determined from equations such as provided herein, or lookup tables, databases, curves, schedules, etc. Databases such as depicted or described herein (e.g., FIG. 3) may include interpolations or extrapolations to one or more setpoints between or beyond discrete values that may be included in the database.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a heating element configured to selectively supply heat to a cookware item; and
a controller operably connected to the heating element, the controller configured to perform operations, the operations comprising:
obtaining an initial temperature setpoint;
obtaining, based on the initial temperature setpoint, a preheating phase duration and an initial power level;
initiating a preheating operation based on the preheating phase duration and the initial power level;
obtaining one or more temperature setpoint changes each corresponding to respective setpoint change times during the preheating operation, wherein each temperature setpoint change comprises a respective second power level;
adjusting the preheating operation to an adjusted power level, wherein the adjusted power level is based on:
a first attribute comprising the preheating phase duration and the sequentially latest power level of the one or more temperature setpoint changes,
a second attribute comprising a sum of each power level applied during the preheating phase duration, and each elapsed duration over which each power level is applied during the preheating phase duration, and
a ratio of a difference of the first attribute and the second attribute to a difference of the preheating phase duration and a sum of each elapsed duration over which each power level is applied.

2. The cooking appliance of claim 1, the operations comprising:
discontinuing the preheating operation at a completion time corresponding to the preheating phase duration.

3. The cooking appliance of claim 1, wherein adjusting the preheating operation does not exceed a maximum power level of the cooking appliance.

4. The cooking appliance of claim 1, wherein obtaining the initial temperature setpoint corresponds to start of the preheating operation.

5. The cooking appliance of claim 4, wherein obtaining one or more temperature setpoint changes is in serial sequence corresponding to respective setpoint change times, setpoint durations, and power levels.

6. The cooking appliance of claim 1, comprising:
a temperature sensor configured to monitor a temperature of a cookware item, the temperature sensor operably connected to the controller to perform operations from a starting temperature obtained from the temperature sensor.

7. The cooking appliance of claim 1, wherein obtaining the initial temperature setpoint and obtaining the one or more temperature setpoint changes comprise receiving a user input.

8. A cooking appliance comprising:
a heating element configured to selectively supply heat to a cookware item; and
a controller operably connected to the heating element, the controller configured to perform operations, the operations comprising:
obtaining an initial temperature setpoint;
obtaining, from a database, a preheating phase duration corresponding to the initial temperature setpoint;
obtaining, from the database, an initial power level corresponding to the initial temperature setpoint;
initiating a preheating operation based on the preheating phase duration and the initial power level;
obtaining, at a setpoint change time during the preheating operation, a temperature setpoint change;
obtaining, from the database, a second power level corresponding to the temperature setpoint change;
adjusting the preheating operation to an adjusted power level during the preheating phase duration, wherein the adjusted power level is based on:
a first attribute comprising the preheating phase duration and the second power level,
a second attribute comprising a duration over which the initial temperature setpoint was active and the initial power level at which the preheating operation is performed, and
a ratio of a difference of the first attribute and the second attribute to a difference of the preheating phase duration and the duration over which the initial temperature setpoint was active.

9. The cooking appliance of claim 8, the operations comprising:
discontinuing the preheating operation at a completion time corresponding to the preheating phase duration.

10. The cooking appliance of claim 8, wherein obtaining the initial temperature setpoint corresponds to start of the preheating operation.

11. The cooking appliance of claim 10, wherein obtaining the temperature setpoint change comprises one or more temperature setpoints in serial sequence corresponding to respective setpoint change times, setpoint durations, and power levels.

12. The cooking appliance of claim 11, the operations comprising:
adjusting, during the preheating phase duration, the preheating operation to a second adjusted power level after adjusting the preheating operation to the adjusted power level.

13. The cooking appliance of claim 12, wherein the second adjusted power level is based on a ratio of a difference of the first attribute and the second attribute comprising a sum of durations each corresponding to the one or more temperature setpoints and one or more sequentially latest power levels, and a difference of the preheating phase duration and a sum of durations corresponding to the one or more temperature setpoints.

14. The cooking appliance of claim 1, comprising:
a temperature sensor configured to monitor a temperature of a cookware item, the temperature sensor operably connected to the controller to perform operations from a starting temperature obtained from the temperature sensor.

15. A method for operating a closed loop cooking appliance, the cooking appliance comprising a heating element and a temperature sensor, the method comprising:
obtaining a first temperature setpoint;
obtaining, from a database, a preheating phase duration and a first power level corresponding to the first temperature setpoint;
initiating a preheating operation based on the preheating phase duration and the first power level corresponding to the first temperature setpoint;
obtaining, at a setpoint change time during the preheating operation, a second temperature setpoint;
obtaining, from the database, a second power level corresponding to the second temperature setpoint; and
adjusting the preheating operation to an adjusted power level, wherein the adjusted power level is based on;
a first attribute comprising the preheating phase duration and the second power level,
a second attribute comprising a duration over which the first temperature setpoint was active and the initial power level, and
a ratio of a difference of the first attribute and the second attribute to a difference of the preheating phase duration and the duration over which the first temperature setpoint was active.

16. The method of claim 15, the method comprising:
discontinuing the preheating operation at a completion time corresponding to the preheating phase duration.

17. The method of claim 15, wherein obtaining the first temperature setpoint comprises obtaining an initial temperature setpoint corresponding to start of the preheating operation.

18. The method of claim 16, wherein obtaining the second temperature setpoint comprises one or more temperature setpoints in serial sequence corresponding to respective setpoint change times, setpoint durations, and power levels.

19. The method of claim 18, the method comprising:
adjusting, during the preheating phase duration, the preheating operation to a second adjusted power level after adjusting the preheating operation to the adjusted power level.

20. The method of claim 19, wherein the second adjusted power level is based on a ratio of a difference of the first attribute and the second attribute comprising a sum of durations each corresponding to the one or more temperature setpoints and one or more sequentially latest power levels, and a difference of the preheating phase duration and a sum of durations corresponding to the one or more temperature setpoints.
